(19) United States
(12) Patent Application Publication
(10) Pub. No.: US 2007/0116609 A1
(43) Pub. Date: May 24, 2007

(54) Microfluidic arrangement for microfluidic optical detection

(76) Inventors: Martin Baeuerle, Buehlertal (DE); Hans-Peter Zimmermann, Waldbronn (DE); Konstantin Choikhet, Karlsruhe (DE); Tobias Preckel, Marxzell (DE)

Correspondence Address: PERMAN & GREEN, 425 POST ROAD, FAIRFIELD, CT, 06824, US

(21) Appl. No.: 11/654,210

(22) Filed: Jan. 17, 2007

(30) Foreign Application Priority Data
Jul. 22, 2004 (EP) PCT/EP02/51577

(51) Int. Cl. B01L 3/02

(52) U.S. Cl. 422/100

(57) ABSTRACT

A microfluidic arrangement (1) for the optical detection of fluids is provided, comprising a microfluidic device (2) having at least one first channel (3) with an opening (4) which is in fluid communication with an optical detection unit (6) of an optical device (5); the microfluidic device (2) being operatively detachably coupled with the optical device (5) whereby an extension of the part (7,7′) of relevance of the optical detection path (17) is provided. A method for detecting fluids using the arrangement of the present invention is provided.

### BACKGROUND ART

The present invention relates to optical detection units in communication with microfluidic devices.

In sample analysis instrumentation, and especially in separation systems such as liquid chromatography and capillary electrophoresis systems, smaller dimensions generally result in improved performance characteristics and at the same time result in improved preparation and analysis efficiency due to time saving based on short residence times in the system and reduced consumption of solvents and additives. Miniaturized separation systems enable scientists to obtain research results despite of using very small volumes of rarely available or difficult to prepare chemical or biological materials.

Analysis of a substance being separated or prepared in the miniaturized column device is conducted while the substance is passing through the column. Preferably, an optical detection technology is selected: UV/Vis, fluorescence, refractive index (RI), Raman and spectroscopic technologies or the like.

Several miniaturized systems have been described in the art aiming to provide miniaturized microfluidic devices. See U.S. Pat. No. 6,033,628 to Swedberg et al. Herein a combination of a device material providing chemical inertness and an optical detection means in compact form coupled with the miniaturized column device is disclosed.

U.S. Pat. No. 6,093,362 to Kaltenbach et al. discloses an optical detection means ablated in a substantially enhanced detection path length on which the reliability of optical detection results depend.

Suggestions how to optimize the pathlength can be found in U.S. Pat. No. 5,571,410 to Swedberg et al., and in U.S. Pat. No. 5,500,071 to Kaltenbach et al.

### DISCLOSURE OF THE INVENTION

It is an object of the invention to provide an improved optical detection on microfluidic arrangements. The object is solved by the independent claims. Preferred embodiments are shown by the dependent claims.

Embodiments of the present invention address the aforementioned needs in the art and provide a microfluidic arrangement having an optimized path length of the optical detection path.

Embodiments of the invention show a microfluidic arrangement combined of a polymeric device to carry out a desired chemical, physical or biological process, which stands in fluidic communication with a second component serving as part of an optical device. An improvement of the present invention is an optical detection unit being the main component of the optical device, providing an extension of light path or detection path, respectively, permitting to obtain a reliable optical detection.

In a first embodiment of the invention the microfluidic arrangement is composed in that the surface of a microfluidic device with a planar geometry is coupled with the bottom surface of an optical detection unit of an optical device. The microfluidic device comprises a channel carrying the fluid being analyzed, which channel stands in fluidic communication with a channel of the optical detection unit, providing a detection path along its longitudinal axis. After having been detected, the fluid flows back into the substrate.

In a second embodiment of the invention the microfluidic arrangement is substantially composed as in the embodiment depicted before, but the fluid is permitted to flow into the channel of another substrate after having passed the channel of the optical detection unit.

In a third embodiment of the present invention the microfluidic arrangement is substantially composed as in the first embodiment, but the detection path is arranged normal to the channel being comprised in the optical detection unit.

In a fourth embodiment of the present invention the microfluidic arrangement is composed of a microfluidic device with a planar geometry comprising a channel, which opens to the top and to the bottom surface of the substrate; the top surface being coupled with the bottom surface of an optical detection unit of an optical device. In this case the optical detection unit serves as a spacer between the substrate and coupling parts of the optical device.

### BRIEF DESCRIPTION OF DRAWINGS

Other objects and many of the attendant advantages of embodiments of the present invention will be readily appreciated and become better understood by reference to the following more detailed description of preferred embodiments in connection with the accompanied drawings. Features that are substantially or functionally equal or similar will be referred to with the same reference signs. The Figures show:

FIG. 1a a schematic cross sectional side view of an optical detection unit,

FIG. 1b a schematic partial cross sectional side view of a microfluidic device,

FIG. 1c a schematic cross sectional side view of a microfluidic arrangement, comprising the optical detection unit of FIG. 1a, a light emitting source, a light receiver and the microfluidic device partially shown in FIG. 1b,

FIG. 1d a schematic cross sectional side view of an optical device with an optical detection path which is aligned with the longitudinal axis of the optical detection unit,

FIG. 2 a schematic cross sectional side view of a microfluidic arrangement with an optical detection unit being in active communication with two partially shown microfluidic devices,

FIG. 3a a schematic partial cross sectional side view of a microfluidic device with a partial surface coating,

FIG. 3b a schematic cross sectional side view of a microfluidic arrangement, comprising the optical detection unit of FIG. 1a and the microfluidic device with a partial surface coating, as shown in FIG. 3a,

FIG. 3c a schematic cross sectional side view of the microfluidic arrangement of FIG. 3b, and light emitting source and light receiver, the light detection path being arranged normal to the longitudinal axis of the optical detection unit,

FIG. 4a a schematic cross sectional side view of a microfluidic device being coupled with another embodiment of the optical detection unit, herein serving as spacer between the microfluidic device and light coupling devices,

FIG. 4b shows only the optical device of FIG. 4a and additionally a light emitting and receiving device, clearly pointing out the extension of the optical detection path.

### DETAILED DESCRIPTION OF DRAWINGS

Analysis of the substance being separated or prepared in the miniaturized column device is conducted while the substance is passing through the column. Preferably, an optical detection technology is selected such as UV/Vis, fluorescence, refractive index (RI), Raman and spectroscopic technologies or the like.

In order to produce reliable results several requirements have to be considered:

The device material must comprise optical properties permitting to carry out the desired technology, effects like self emittance, self fluorescence, respectively, absorption of light etc. must be excluded.

At the same time the miniaturized analysis device ought to be made from a chemical inert material, not showing reactivity of the device material with the analysis reagents, to name the dissolution of silicon dioxide devices in basic conditions. Accordingly, it's almost impossible to find a material that meets as well the optical as the chemical requirements.

Furthermore it has to be taken into account that in conventional capillary electrophoresis (CE) technology the optical detection is generally performed on-columns by a single pass detection technique, wherein electromagnetic energy is passed through the sample, the light beam traveling normal to the capillary axis and crossing the capillary only a single time. Accordingly, the detection path length is depending on the diameter of the capillary or column, channel, respectively.

Considering the Law of Lambert and Beer it can be seen clearly that the intention to minimize the column device, including minimization of the diameter of the capillary, leads to a reduction of the light path and therefore to an decreased precision of the results.

The universal formula of the law gives the change in intensity di, of light having a wavelength λ, in dependency of an absorbing species across a segment having a thickness x

$$\frac{di}{i} = - {α}_{λ} \cdot c \cdot dx \qquad Eq . 1$$

with α=proportionality factor, depending on λ
c=usually concentration (mol/l); may as well be another chemical property not directly depending on concentration.

Integrating over the thickness x of the segment gives the change of the intensity of the light l₀ entering the segment x—which herein is the fluid flowing through the capillary—and the light l exiting the capillary. Assuming that the absorbing species is homogeneously distributed in the sample and solving the integral leads to:
l=I₀·e^{α·d} Eq. 2.

Transformation gives the absorbance A which is dimensionless:

$$\begin{matrix}A = lg \frac{{I}_{0}}{I} \\ = - lgT \\ = {ɛ}_{λ} \cdot c \cdot d\end{matrix} \qquad Eq . 3$$

with

$$\begin{matrix}{ɛ}_{λ} = \frac{{α}_{λ}}{ln 10} , \\ ɛ = the molar absorptivity ( l / mol \cdot cm ) .\end{matrix} \qquad Eq . 5$$

It can be seen that the absorbance increases linearly with the pathlength, which is the parameter to be optimized.

Since the absorption is correlated with transmission T and reflection R according to the following relationship
1=A+R+T Eq. 6,
wherein “1” is 100% of the light entering the segment dx, it can be readily understood that an increased pathlength of the light affects each optical detection based on absorption, transmission or reflection measurements.

Before the invention is described in detail, it is to be understood that this invention is not limited to the particular component parts of the devices described or to process steps of the methods described as such devices and methods may vary. It is also to be understood, that the terminology used herein is for purposes describing particular embodiments only and it is not intended to be limiting. It must be noted that, as used in the specification and the appended claims, the singular forms of “a”, “an”, and “the” include plural referents until the context clearly dictates otherwise. Thus, for example, the reference to “a detection device” includes two or more such devices; “a channel” or “the channel” may as well include two or more channels where it is reasonable in the sense of the present invention.

In this specification and in the claims which follow, reference will be made to the following terms which shall be defined to have the herewith explained meanings:

The term “microfluidic device” is used herein to refer to any material which is light-absorbing and capable of being ablated, particularly laser-ablated, and which is not silicon or a silicon dioxide material such as quartz, fused silica or glass like borosilicates. Accordingly, miniaturized column devices or devices comprising channels for separation or preparative purposes are formed herein using suitable substrates such as laser ablatable polymers (including polyimides and the like) and ceramics (including aluminum oxides and the like), thus being “microfluidic devices”. Further, miniaturized column devices are formed herein using composite substrates such as laminates.

A “laminate” refers to a composite material formed from several different bonded layers of the same or different materials.

As used herein, an “optical detecting device” refers to any means, structure or configuration that allows one to interrogate a sample within a-definite compartment using optical analytical techniques known in the art. Thus, an “optical detecting device” comprises a light emitting source and a means to receive light being reflected or transmitted by the sample.

By the arrangement of a light emitting source and a receiver (means for receiving radiation) an “optical detection path” is formed, permitting electromagnetic radiation to travel from the light emitting source to the receiver, thereby traversing a sample being present within a compartment on the optical detection path. Thus, a variety of optical detection techniques can be readily interfaced with the part of the optical detection path including, but not limited to, UV/VIS, Near IR, fluorescence, refractive index (RI) and Raman index.

The “optical detection unit” is that component of the optical detection device that surrounds the compartment or part, respectively, of the optical detection path that contains the sample while it is traversed by the electromagnetic radiation.

In the following, the term “fluid” is used synonymously to “sample” since the focus is laying onto the analysis of fluid media no matter if they are subjected to a separation process or to a preparative process. The fluid may contain particles.

The term “channel” refers to any passage in the substrate that is suitable for carrying fluids. Depending on its specific use, the channel may serve as a separating device, which filled with a packing or the like, being a column then, or it, may be of a very small size, being a capillary then.

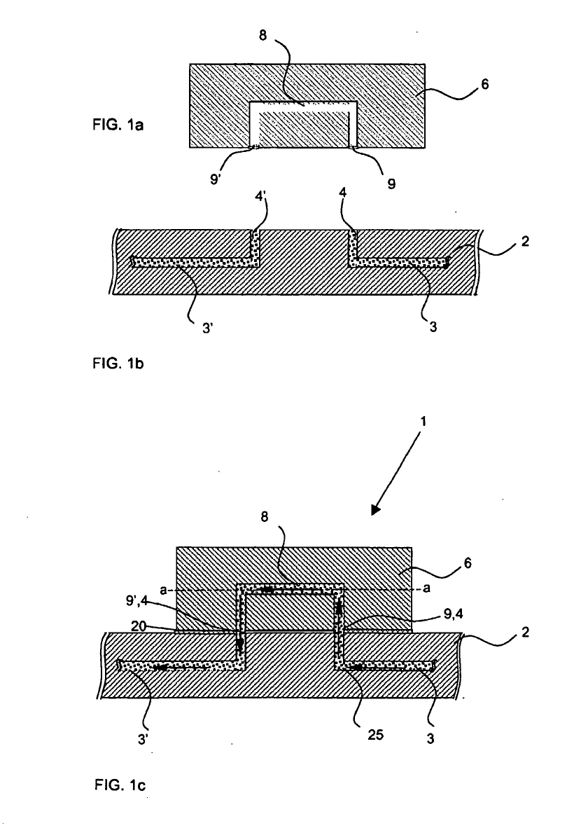

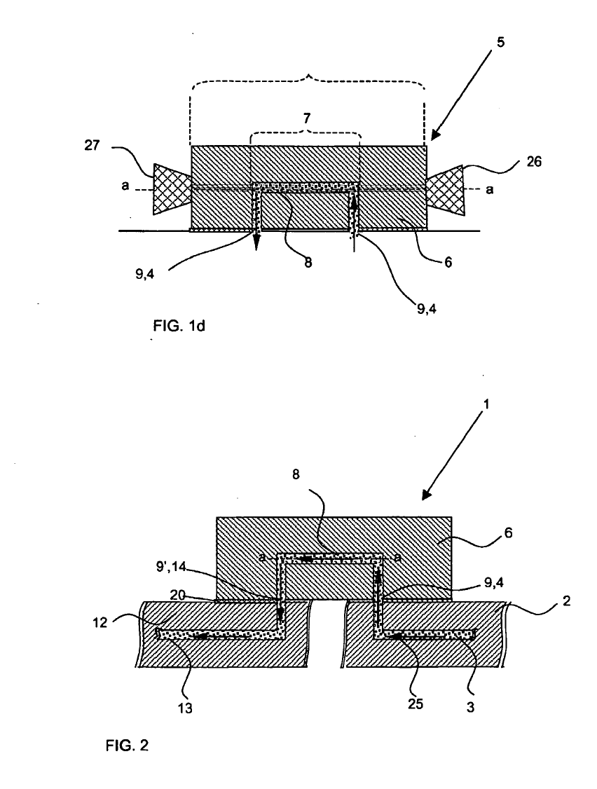

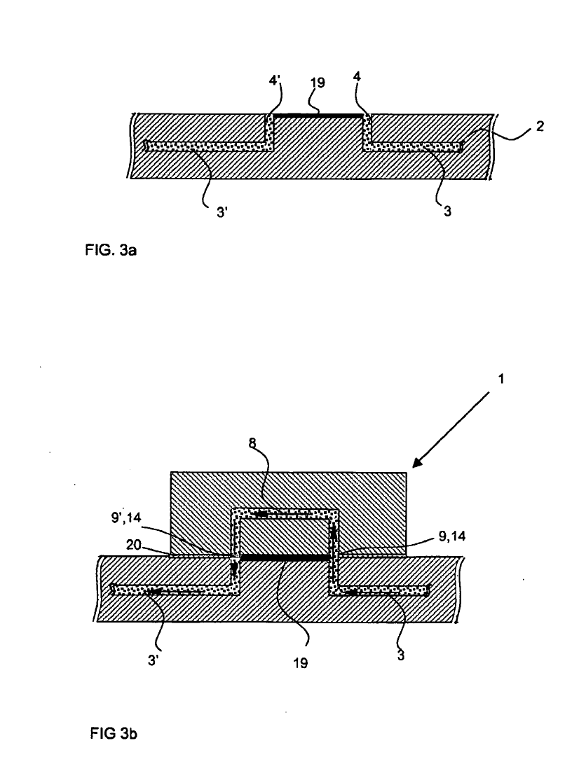

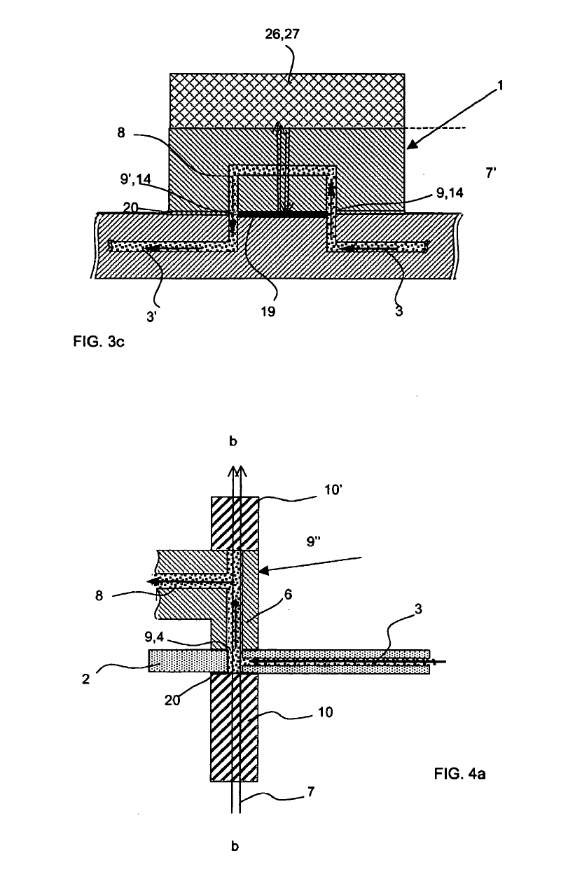

Referring now to FIG. 1a, an optical detection unit 6 can be seen, which is the main component of an optical device 5, shown in FIG. 1d. It includes at least one channel 8 having a longitudinal axis a-a with a first opening 9 and a second opening 9′, both opening to the bottom surface of the optical detection unit 6, which faces the upper surface of the microfluidic device 2 shown in FIG. 1b.

In FIG. 1c the microfluidic arrangement 1 is shown, being comprised of the microfluidic device 2 of FIG. 1b, which herein has a channel 3 with an opening 4 and another channel 3′ with an opening 4′, both opening to the upper surface of the substantially planar microfluidic device 2. As can be seen, the microfluidic device 2 is coupled with the optical device 6 in a position performing an overlapping of the openings 4 and 9, thus permitting a fluid being contained in the channel 3 to pass the opening 4 in order to flow via the opening 9 into the channel 8 of the optical detection unit 6. Thus, a fluid communication between optical device 6 and microfluidic device 2 is obtained.

In FIGS. 1b,c (and 3a,b,c), the fluid is flowing back into the microfluidic device 2 by passing a second opening 9′ of the channel being comprised in the optical detection unit 6, which is exactly congruent with the opening 4′ of the channel 3′. The channel 3′ could be seen as a continuation of the channel 3. Thus, a process that is not already finished may be continued. The fluid flow is driven by a moving force as it is known in the art; the moving force shall not be focused closer herein.

As it is depicted in FIG. 1d, the optical device provides a part 7 of an optical detection path 17 along the longitudinal axis a-a. With respect to equations 1-6, the precision of results obtained by optical detection techniques which base on the traversing of electromagnetic radiation through a sample is the better the longer the optical path is; accordingly one can design an optical detection unit with an appropriate length of the path 7, depending on the requirements of the fluid to detect.

As can be seen in FIG. 1d, the electromagnetic radiation applied in the setting of FIG. 1c is emitted by a light emitting source 26 and directed along the optical detection path 17, traversing the fluid that flows through the channel 8 along the longitudinal axis a-a and is then received by the receiver 27. Accordingly, the extension of the relevant part 7 of the optical detection path 17 depends of the length of the channel 8, which can be considered when this component is manufactured und thus can be adapted custom tailored with respect to the specific needs of the optical detection technique to be applied. It must be pointed out that independent from the extension of the relevant part 7 of the detection path 17 any effects basing on the optical properties of the microfluidic device 2 should be excluded. This advantage characterizes each of the embodiments described herein.

The microfluidic device of the embodiment shown in FIGS. 1a-1c is only shown partially; it could be sized large enough to include a plurality of channels.

Since the microfluidic device 2 needs only to be detachably coupled with the optical detection unit 6 during the operation of the optical detection, the optical device 5 is available for numerous measurements. Accordingly, a microfluidic device might be detached after a detection operation has been performed, subsequently it could be coupled in another position, creating a new passageway between the opening 9 and an opening of another channel that is comprised in the substrate. (This is not shown in the drawings.)

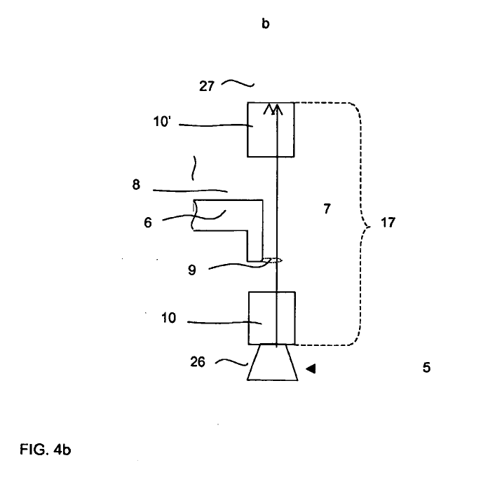

FIG. 2 shows an embodiment pointing out that the fluid may be lead a second microfluidic device 12, having a channel 13 with an opening 14, which opens to the surface of the second microfluidic device 12. The opening 14 is positioned that way, that it overlaps the second opening 9′ of the channel 8 of the optical detection unit 6.

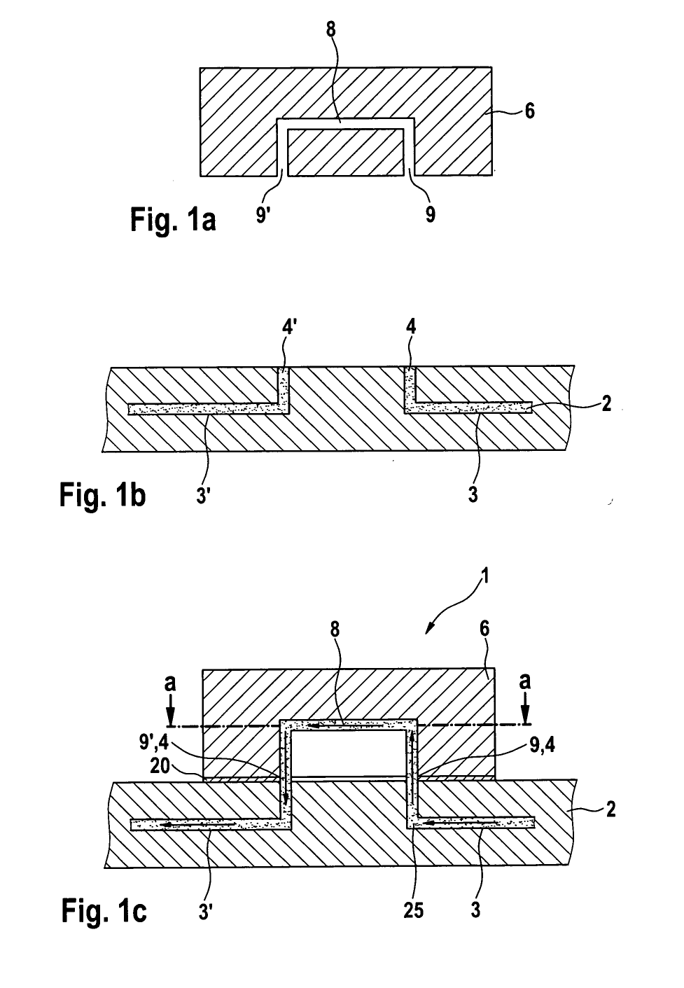

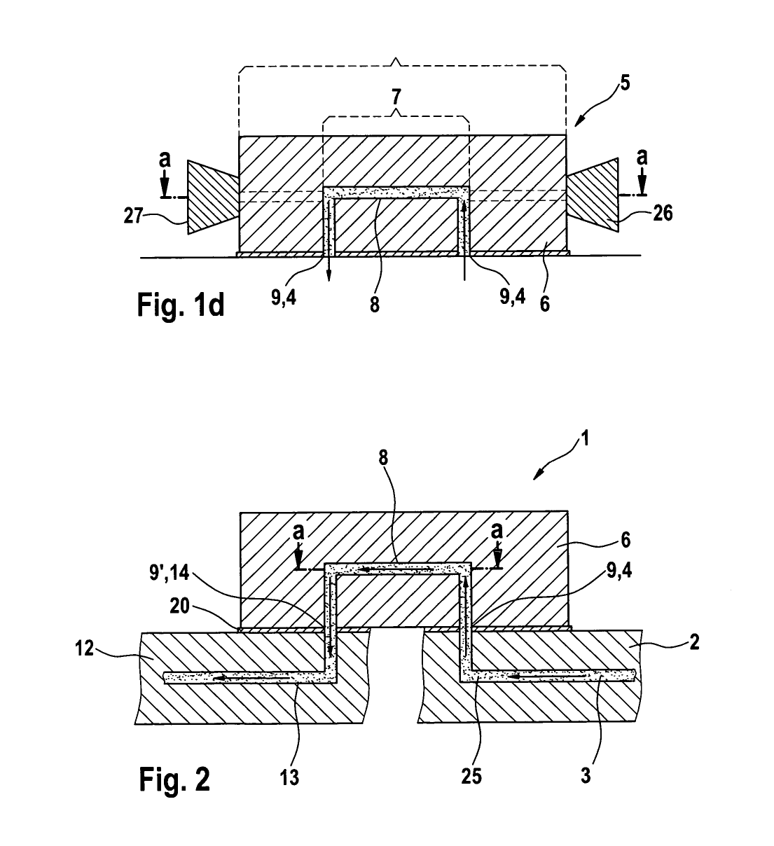

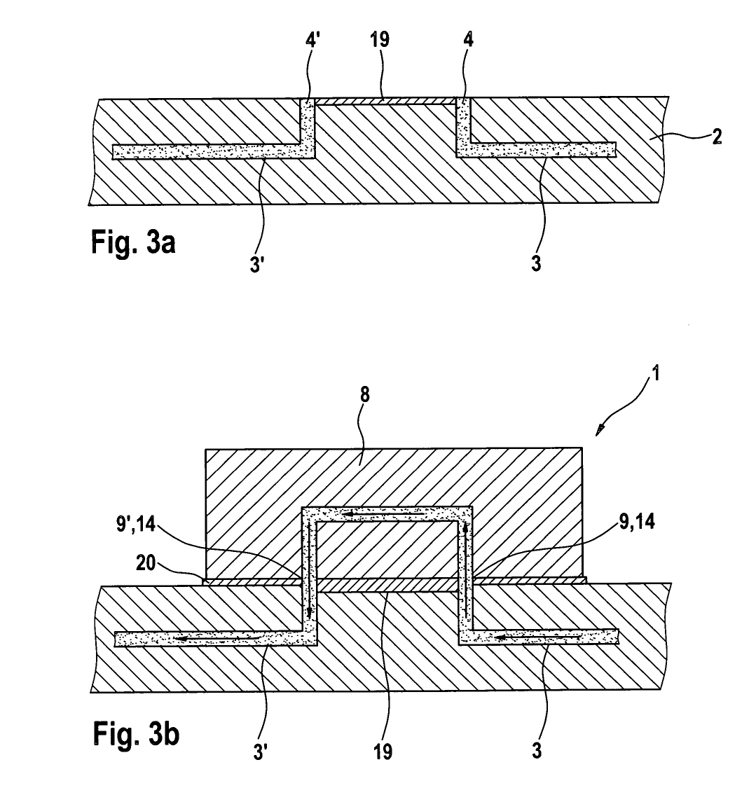

FIGS. 3b and 3c show a design wherein the optical detection path 17 is arranged normal to the channel 8 of the optical detection unit 6. The length of the part 7′ of the optical detection path 17 may be extended by widening of the channel, which is not shown in the FIGS. In order to prevent disadvantageous influence of the microfluidic device 2, which is positioned in the optical detection path 17, a coating of the surface of the microfluidic device has to be provided. The coating may be partial, as can be seen in FIGS. 3a, 3b and 3c. It can be seen in FIG. 3c that the light emitting source 26 and the receiver 27, too, are arranged normal to the longitudinal axis a-a of the channel 8.

Taking into consideration that the optical device 5 including the optical detection unit 6 could be installed in an immobile apparatus, while the substrates containing fluids, which need to be analyzed, are mobile, just being coupled for the duration of the analysis, one is capable to design a most efficient detection apparatus and technique with the herein disclosed invention.

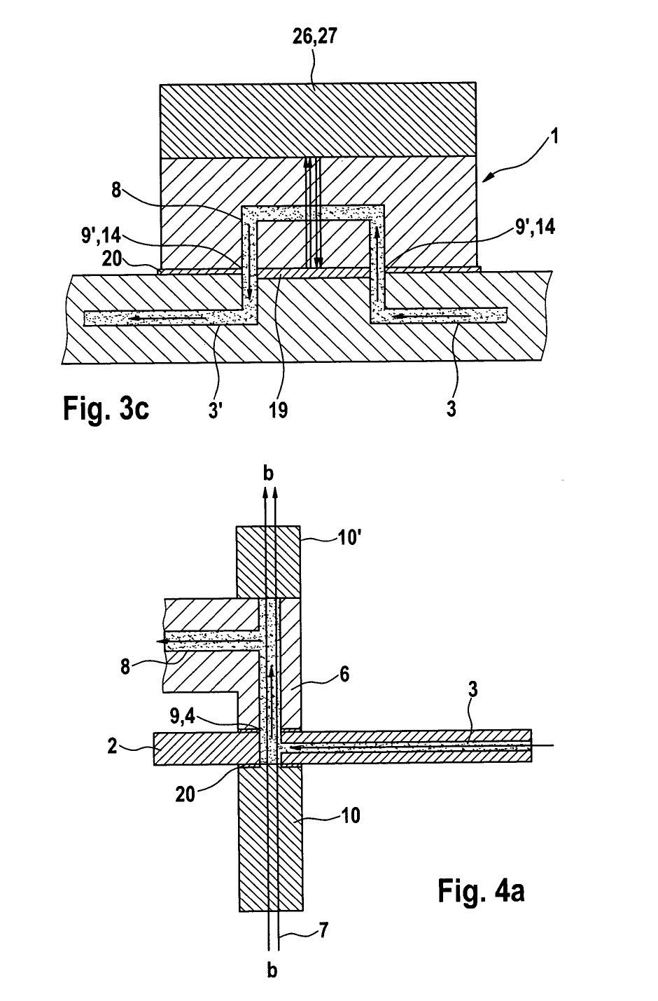

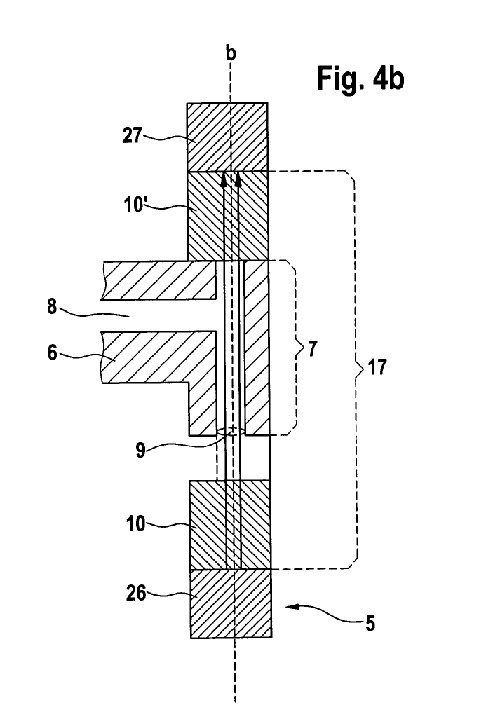

FIG. 4a refers to a microfluidic device 2 wherein the opening 4 of the channel 3 extends from the upper surface to the bottom surface of the microfluidic device 2, thus the channel is being shaped like a “T”. The passage formed from one to the other opening may be a through hole. The optical detection unit is coupled with an optical detection unit 6 having a channel 8 having three openings 9, 9′ and 9″ and being shaped like a “T”, too. The microfluidic device 2 is positioned in a way that the opening 4 of the microfluidic device 2 interfaces the opening 9 of the optical detection unit 6, accordingly permitting a fluid being contained in the channel 3 to flow into the channel 8 via the passage constituted by the openings 4 and 9. The optical detection unit 6 is additionally coupled with a coupling device 10′, being part of the optical detection unit 5. The microfluidic device 2, too, is attached at its bottom surface to a coupling device 10. Adjacent to the coupling device 10 a light emitting device 26 and adjacent to the coupling device 10′ a receiver is installed; all of which being part of the optical detection unit 5.

In this arrangement, the optical detection unit 6 is a spacer between the microfluidic device 2 and the optical coupling device 10′. An axis b-b joins the centers of the openings 9″, 9 and the center of the through hole of the microfluidic device. The optical detection path 17 is congruent with the axis b-b, beginning at the light emitting source 26 and ending at the receiver 27. In analogy to what has been shown in FIG. Id, the spacer serves to extend the part 7 of the optical detection path 17 that traverses the fluid. Again, the precision of results obtained by an optical detection technique mentioned herein is based on the length of the optical path containing fluid.

The spacer offers a possibility to design or to extend the required optical detection path, more precisely the part 7 which can be filled with fluid, as can be seen in FIG. 4b. Furthermore, this design guarantees that there are no effects influencing the detection result which are based on material properties of the microfluidic device (2).

Any interfaces of channels, particularly those interfaces between the microfluidic device 2 and parts of the optical device, need to be positioned precisely, which means that openings being interconnected have to be brought in congruence. This could be facilitated by position holders as pins, for example, which can be mounted on the devices. Furthermore, the openings have to be fixed tightly one on another and they should be sealed with a high-pressure proof sealing in order to prevent leakage due to the pressure of the fluid. The pressure that has to be resisted may reach about 200 bar.

The optical detection unit 5 of any embodiment is preferably transparent, at least partially. It could be made from silicon or a silicon dioxide material such as quartz, fused silica or glass as like borosilicate or the like.

The method for optically detecting fluids being processed in microfluidic devices can be performed in any embodiment of a microfluidic arrangement according to the present invention. This requires attaching a microfluidic device to an optical device of the present invention. The operation of attaching the components of the microfluidic arrangement should be carried out precisely, guaranteeing an optimal overlapping of openings provided in the components facing each other. To optimize the connection or adhesion, respectively, a sealing should be applied.

The fluid that flows through the channel or channel system of the microfluidic device is now permitted to transit into the channel being comprised in the optical detection unit, thus passing the part of an optical detection path, which is traversed by electromagnetic radiation during the operation of detection.

The fluid can be moved with conventional moving means in order to obtain a definite flow through rate when the fluid passes the part of an optical detection path that is relevant for detection.

Leaving the channel of the optical detection unit, the fluid can be moved back into its microfluidic device of origin or into any other one, depending on the requirements of the process one is carrying out.

The light can be directed versus the probe directly or by coupling means; it can be directed along a longitudinal axis of the optical device or normal to it.

The present invention thus provides a microfluidic arrangement with, combining a microfluidic device material being chemically inert with respect to the processes to be performed with an optical device having optimal optical properties permitting to carry out the desired technology. It is furthermore most advantageous, that the material that is selected for the microfluidic device can be opaque while the material selected for the optical device is transparent, both combined together performing an extraordinary microfluidic arrangement, which fulfills the optical and chemical requirements. Additionally the microfluidic arrangement can be used flexible, allowing economic handling of the detection since the optical device can be used for a number of detections with differing microfluidic devices.

1. Microfluidic arrangements comprising:
at least one microfluidic devices having at least one first channel with an opening to a surface of the microfluidic device,
an optical detection unit providing at least a part of an optical detection path and
comprising at least one channel with a first opening opening to a surface of the optical detection unit (6), wherein the surface of the optical detection unit is facing the surface of the microfluidic device when the at least one microfluidic device is operatively coupled with the optical device, so that the at least one channel of the optical detection unit is in fluid communication with the at least one first channel of the microfluidic device by coupling the opening of the at least one first channel with the first opening of the at least one channel.

2. The arrangement of claim 1, wherein the optical detection unit is at least partially transparent.

3. The arrangement of claim 1, wherein the microfluidic device has a substantially planar geometry.

4. The arrangement of claim 1, wherein the at least one channel has at least one second opening opening to the surface of the optical detection unit.

5. The arrangement of claim 1, wherein the at least one microfluidic device is detachably coupled with the optical device.

6. The arrangement of claim 1, wherein the part of the optical detection path is aligned with a longitudinal axis of the at least one channel.

7. The arrangement of claim 1, wherein the part of the optical detection path is arranged substantially normal to the at least one channel.

8. The arrangement of claim 1, wherein the optical detection unit is applicable for fluorescence, UV/VIS, near IR, refractive index and Raman index optical detection techniques.

9. The arrangement of claim 1, wherein the opening of the at least one first channel of the at least one microfluidic device extends from an surface facing the optical detection unit to an opposing surface of the microfluidic device.

10. The arrangement of claim 1, wherein the opening extending from the surface facing the optical detection unit to the opposing surface of the microfluidic device is a through hole.

11. The arrangement of claim 1, wherein the optical detection unit is an interconnection between a first microfluidic device and a second microfluidic device thus providing fluid communication between the first microfluidic device and the second microfluidic device.

12. The arrangement of claim 1, wherein the at least one channel of the optical detection unit is in fluid communication with at least one second channel having an opening being comprised in the first microfluidic device in that the at least one second opening of the at least one channel is coupled with the opening of the at least one second channel.

13. The arrangement of claim 1, wherein the microfluidic arrangement comprises a polymer device, in particular a Kapton® substrate.

14. The arrangement of claim 1, wherein the microfluidic device has a surface at least partially provided with a coating suppressing foreign radiation, in particular foreign radiation caused by the material of the microfluidic device.

15. The arrangement of claim 1, wherein the optical detection unit is made of quartz, fused silica, glass, borosilicate glass or any material suitable to constitute an optical detection unit.

16. The arrangement of claim 1, wherein the optical device comprises at least one of a light emitting source and a light receiver.

17. The arrangement of claim 16, wherein the optical device comprises at least one optical coupling device directing the light emitted by the light emitting source into the microfluidic device or the light coming from the optical detection unit into the light receiver.

18. The arrangement of claim 17, wherein the at least one optical coupling device is detachably coupled adjacent to the at least one microfluidic device and provides a part of an extension of the optical detection path.

19. The arrangement of claim 17, wherein at least one optical coupling device is detachably coupled adjacent to the optical detection unit and provides a part of an extension of the optical detection path.

20. The arrangement of claim 17, wherein the optical detection unit is a spacer being a component providing an extension of the optical detection path between the microfluidic device and the optical coupling device.

21. The arrangement of claim 20, wherein the at least one channel of the spacer has an opening facing the coupling device.

22. The arrangement of claim 10, wherein the opening, the first opening and the through hole of the microfluidic device are coaxially arranged with respect to an axis.

23. The arrangement of claim 1, wherein the optical device comprises the optical detection unit, the optical coupling devices, the light receiver, the light emitting device as compounds and wherein a high pressure proof sealing is providing an adhesion between at least one of the compounds constituting the optical device and the microfluidic device.

24. The arrangement of claim 1, wherein the optical detection unit is positioned to the microfluidic device by position holders.

25. The arrangement of claim 24, wherein the position holders comprise pins.

26. A method for optically detecting fluids being processed in microfluidic devices used in microfluidic arrangements, comprising operatively coupling a microfluidic device with the optical detection unit of the optical device, thus extending the part of the optical detection path.

27. The method of claim 26, wherein a fluid flowing through the at least one channel of the optical detection unit is directed into a second microfluidic device via a second opening of the at least one channel, which is in fluid communication with an opening of the at least one channel of the second microfluidic device.

28. The method of claim 26, wherein fluid flowing through the at least one channel of the optical detection unit is directed back into the first microfluidic device via the second opening comprised in the at least one channel being in fluid communication with an opening of the at least one second channel of the first microfluidic device.

29. The method of claim 26, wherein the microfluidic device is detached from the optical device after detection.

30. The method of claim 26, wherein light is coupled into the optical device.

31. The method of claim 26, wherein the light is directed along a longitudinal axis of the optical device.

32. The method of claim 26, wherein the light is directed normal to the at least one channel comprised in the optical device.

33. The method of claim 26, wherein the light is directed through at least one optical coupling device being detachably fixed adjacent to the at least one microfluidic device.

34. The method of claim 26, wherein light is directed through an at least one optical coupling device being detachably fixed adjacent to the optical detection unit.

35. The method of claim 26, comprising introducing a spacer between the microfluidic device and the optical coupling device, extending the optical detection path.

36. The method of claim 26, wherein light is emitted from a light emitting source and directed via the optical coupling device along the axis to a light receiver.

37. The method of claim 26, comprising at least partially the covering of the microfluidic device with a surface coating suppressing the self-radiation of the microfluidic device.
